(19) United States
(12) Patent Application Publication
(10) Pub. No.: US 2008/0219350 A1
(43) Pub. Date: Sep. 11, 2008

(54) H.264/AVC intra coding algorithms having quality scalability

(75) Inventors: Jiun-In Guo, Min-Hsiung (TW); Jia-Wei Chen, Min-Hsiung (TW); Chun-Hao Chang, Min-Hsiung (TW)

Correspondence Address: TROXELL LAW OFFICE PLLC, 5205 LEESBURG PIKE, SUITE 1404, FALLS CHURCH, VA, 22041, US

(73) Assignee: National Chung Cheng University, Chia-Yi (TW)

(21) Appl. No.: 11/812,247

(22) Filed: Jun. 15, 2007

(30) Foreign Application Priority Data
Mar. 5, 2007 (TW) 096115764

(51) Int. Cl. H04N 7/26

(52) U.S. Cl. 375/240.15; 375/E07.127

(57) ABSTRACT

Different algorithms are used in H.264/AVC intra coding to form three coding levels. Algorithms used in two of the three coding levels reduce calculation complexities and power consumptions. The basic level is an exception, which fully keeps an original picture quality. Thus, various needs can be met by coding in the various levels with the various algorithms.

### FIELD OF THE INVENTION

The present invention relates to intra coding algorithms; more particularly relates to reducing calculations for obtaining predicted modes and improving a coding efficiency with a quality scalability.

### Description of the Related Arts

H.264/AVC coding system has a luma coding and a chroma coding, where luma coding comprises coding for two types of macroblocks, including intra 4×4 macroblocks (I4MB) and intra 16×16 macroblocks (I16MB). Important intra coding in the H.264/AVC coding system includes intra predictor generation, DCT/Q/IQ/IDCT (discrete cosine transform/quantization/inverse quantization/inverse discrete cosine transform), context-adaptive variable length coding (CAVLC), in-loop filter (ILF) and mode decision. Therein, the intra predictor generation and the mode decision occupy about 70 percents of calculation. It is because the intra prediction must produce 13 luma prediction values and 4 chroma prediction values. The luma prediction values further comprises 9 luma prediction values for an intra 4×4 macroblock and 4 luma prediction values for an intra 16×16 macroblock. The luma and chroma prediction values obtained are then subtracted by corresponding values of the original picture. The subtracted values are processed through a two-dimensional Hadamard transformation to obtain coefficients to be summed for obtaining a best predicted mode. Although calculation for obtaining predicted modes in mode decisions are reduced in this way and an efficiency of the whole system is thus improved, picture quality is affected.

In the other hand, some rapid mode-decision algorithms are found in some documents. One of the rapid mode-decision algorithms is done by setting a threshold value to end the mode decision earlier. A few modes which may more possibly happen are selected for prediction at first. And an assumption is that, if a best predicted cost obtained for one of these modes is bigger than the threshold value, the mode the predicted cost represents is not the best solution and thus the calculation continues through the rest modes; on the contrary, if not bigger, the calculation stops at once. However, the threshold value has to be set for the algorithm in advance and thus the threshold value has a great impact to efficiency. However, there is another algorithm done with a boundary detection, where a most possible mode is predicted through a direction of a boundary detected. Yet, the mode predicted through the direction of the boundary detected is not always correct.

As a result, the above algorithms increase bits and losses in picture quality, and a high cost is required for a hardware application. Hence, the prior arts do not fulfill all users' requests on actual use.

### SUMMARY OF THE INVENTION

The main purpose of the present invention is to provide algorithms for intra coding to obtain a scaleable picture quality.

Another purpose of the present invention is to reduce calculations on obtaining predicted modes and to improve coding efficiencies, where a low-cost hardware is practiced with a high efficiency, a high picture quality and a low power consumption.

To achieve the above purposes, the present invention is H.264/AVC intra coding algorithms having a quality scalability, where coding modes are provided for three types of macroblocks in H.264/AVC intra coding, including intra 4×4 macroblocks, intra 16×16 macroblocks and chroma macro blocks; rapid algorithms, including a CC-SA algorithm, a PCC-SA algorithm, a NDCB-SA algorithm and a QMB-SA algorithm, are provided to obtain three coding levels of level 0, level 1 and level 2; coding algorithms with different complexities are used according to different environments and requirements and a scalable picture quality is further obtained with the three levels of intra coding; and, in the three levels, level 0 has no picture quality loss, and level 1 and level 2 has low calculation complexities and low working frequencies with 38% and 50% calculation saved as cormpared to level 0 respectively. Accordingly, novel H.264/AVC intra coding algorithms for a quality scalability are obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is the flow view showing the preferred embodiment according to the present invention;

FIG. 2 is the view showing the corresponding methods for three intra coding levels;

FIG. 3 is the view showing the condition-correlation search method;

FIG. 4A is the view showing the half-full search method;

FIG. 4B is the view showing the prediction of the half-full search method;

FIG. 5A is the view showing the context-correlation search method;

FIG. 5B is the view showing the prediction of the context-correlation search method;

FIG. 6 is the view showing the CC-SA search table;

FIG. 7 is the view showing the condition-correlation search method of the PCC-SA algorithm;

FIG. 8 is the view showing the probability-correlation search method;

FIG. 9A is the view showing the first prediction of the probability-correlation search method;

FIG. 9B is the view showing the second prediction of the probability-correlation search method;

FIG. 10A is the view showing the non context-correlation search method;

FIG. 10B is the view showing the prediction of the non context-correlation search method;

FIG. 11 is the view showing the PCC-SA search table;

FIG. 12 is the view showing the luma 16×16 macroblock;

FIG. 13 is the view showing the transformed residues of the 4×4 block;

FIG. 14 is the view showing the first color element macroblock lock; and

FIG. 15 is the view showing the second color element macroblock.

### DESCRIPTION OF THE PREFERRED EMBODIMENT

The following description of the preferred embodiment is provided to understand the features and the structures of the present invention.

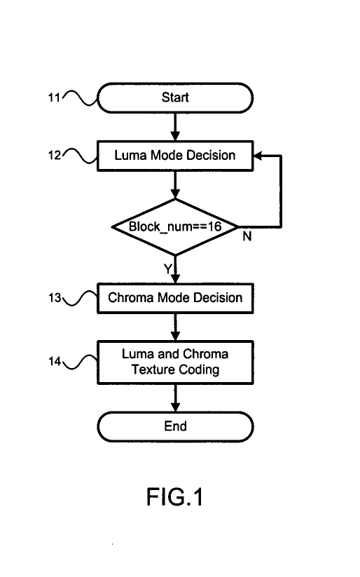

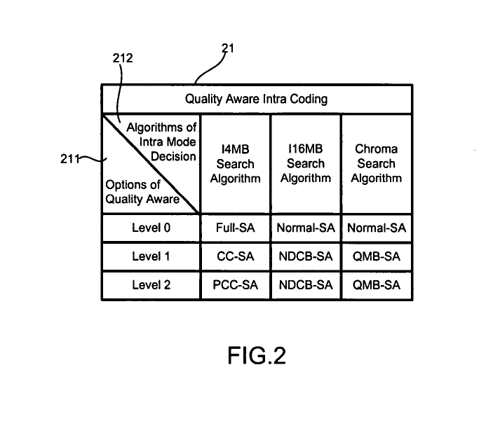

Please refer to FIG. 1 and FIG. 2, which are a flow view showing the preferred embodiment according to the present invention; and a view showing corresponding methods for three intra coding levels. As shown in the figures, the present invention is H.264/AVC intra coding algorithms for a quality scalability, where, in intra coding of H.264/AVC, mode decisions are processed to obtain a scaleable picture quality, comprising the following steps:

(a) When a static coding starts [11], luma mode decisions [12] are processed to intra 4×4 macroblocks and intra 16×16 macroblocks and a chroma mode decision[13 ] is processed to chroma macroblocks. All three macroblocks are processed for mode predictions to obtain best predicted modes separately. Therein, in the intra coding of H.264/AVC, near 70 percents (%) of calculation is processed for intra predictor generation and mode decision, which are the most complex parts. Hence, the present invention provides three coding levels [211] for optimizing the mode decision. Corresponding intra mode decision algorithms 212 for the three coding levels 211 are as follows:

(i) Level 0: Calculation in the level 0 is the most complex. The algorithms used in this level for intra 4×4 macroblocks, intra 16×16 macroblocks and chroma macroblocks include Full-SA (Full Search Algorithm) and Normal-SA (Normal Search Algorithm), which are conformed to international standards and picture quality is not affected.

(ii) Level 1: For obtaining best predicted modes in level 1, a context condition search algorithm (CC-SA), a non DC block search algorithm (NDCB-SA) and a quarter MB search algorithm (QMB-SA) are used for the intra 4×4 macroblock, the intra 16×16 macroblock and the chroma macroblock, respectively. Therein, the CC-SA algorithm and the QMB-SA algorithm save up to 45% and 75% of calculation; and the CC-SA algorithm comprises a condition-correlation search method, a half-full search method and a context-correlation search method for a mode decision.

(iii) Level 2: Level 2 has the least calculation. A probability context condition search algorithm (PCC-SA) is processed to further reduce the calculation for the mode decision of the intra 4×4 macroblock, wherein the PCC-SA algorithm comprises a condition-correlation search method, a probability-correlation search method and a non context-correlation search method.

(b) Then texture coding is processed to the best luma predicted modes and the best chroma predicted

Thus, novel H.264/AVC intra coding algorithms for a quality scalability are obtained.

In this way, the present invention provides H.264/AVC intra coding algorithms for a quality scalability, where intra coding algorithms are selected for mode decisions to be processed with texture coding, and intra coding methods used in the algorithms reduce calculations with picture quality remained.

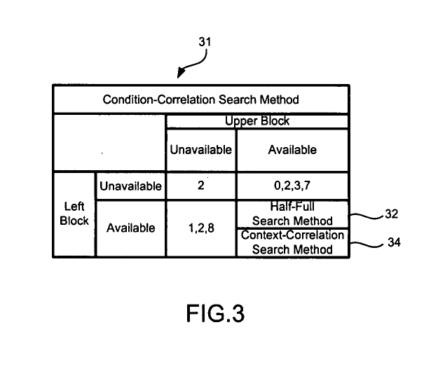

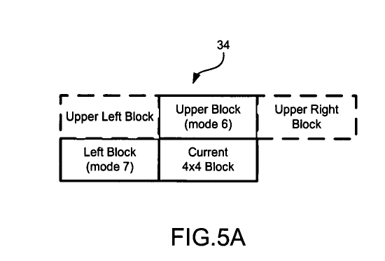

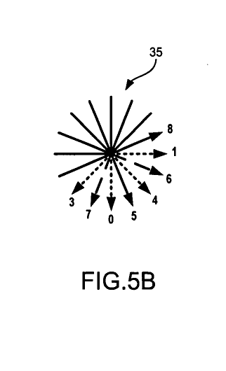

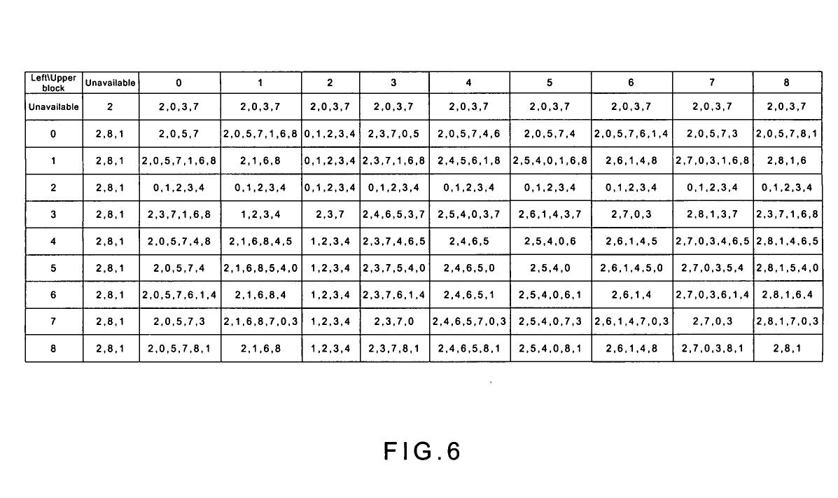

Please refer to FIG. 3 to FIG. 6, which are views showing a condition-correlation search method, a half-full search method, a prediction of the half-full search method, a context-correlation search method, a prediction of the context-correlation search method and a CC-SA search table. As shown in the figures, originally, an intra 4×4 macroblock has 9 predicted modes; then the predicted modes are reduced by referring to existences of the upper and left side blocks to reduce calculations. The search method for obtaining a mode decision according to the existences of the upper and left side blocks is a condition-correlation search method 31. There are four conditions in the condition-correlation search method 31 for obtaining the mode decision; and the modes include mode 0 of a vertical mode, mode 1 of a horizontal mode, mode 2 of a decoding (DC) mode, mode 3 of a diagonal down-left mode, mode 4 of a diagonal down-right mode, mode 5 of a vertical-right mode, mode 6 of a horizontal-down mode, mode 7 of a vertical-left mode and mode 8 of a horizontal-up mode. When there is a upper block but not an left block, only mode 0, mode 2, mode 3 and mode 7 When there is a left block but not an are calculated for a mode decision upper block, only mode 1, mode 2 and mode 8 are calculated for a mode decision. When there are a left block and an upper block, two methods are used for a mode decision, which are a half-full search method 33 and a context-correlation search method 34. In predicted modes for an intra 4×4 macroblock, the predicted modes have their directions except the DC mode and, so, the DC mode is singled out. And, in a natural picture, neighboring blocks have a very high similarity Hence, by using these spatial correlations among blocks, only several possible predicted modes are selected so that calculations are reduced.

No mater what predicted modes the neighboring blocks have, DC mode always has the possibility to become a best predicted mode. If there is a DC mode for any neighboring block, any predicted mode is possible to be selected as the best predicted mode and so all modes have to calculated. Because the DC mode has no specific direction, it is not predicted with a spatial correlation. To simplify the correlation, full-search predicted modes are replaced with cross-direction predicted modes 33. The smaller a picture block is, a better predicted mode is obtained by referring to the neighboring blocks owing to the similarity. Hence, on obtaining the best predicted mode for the intra 4×4 macroblock, not only the original upper and left blocks are selected, but also the predicted modes at the neighboring directions. For example, the context-correlation search method 34 and the predicted mode 34 have mode 6 and mode 7 as the upper predicted mode and the left predicted mode respectively; and, based on the above description, only mode 3, mode 7, mode 0, mode 4, mode 6, mode 1 and mode 2 are selected to be calculated. Accordingly, as shown in FIG. 3, a CC-SA search table is obtained with the condition-correlation search method 31, the half-full search method 32 and the context-correlation search method 34.

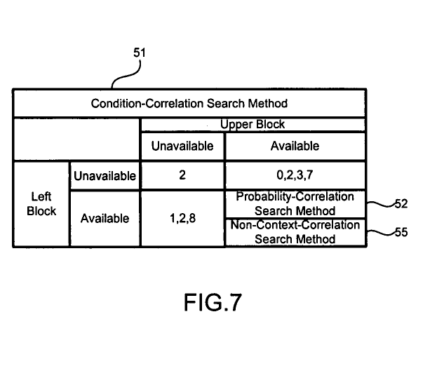

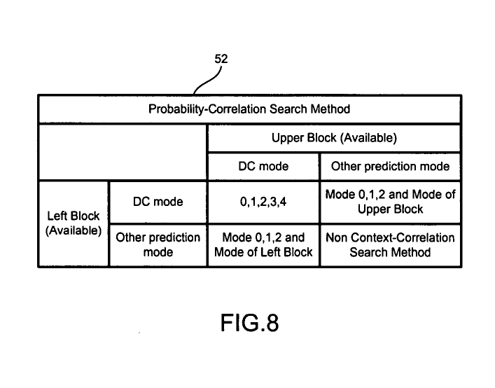

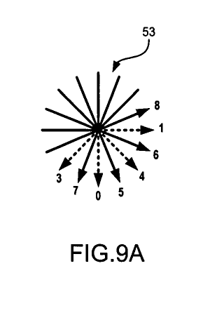

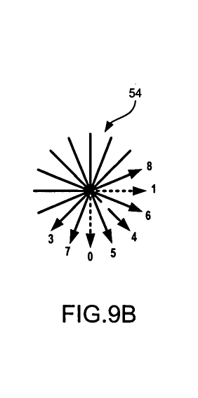

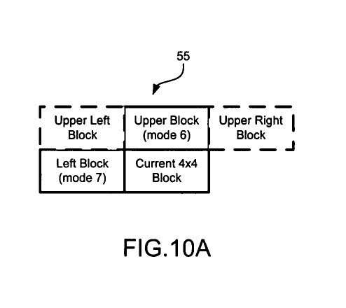

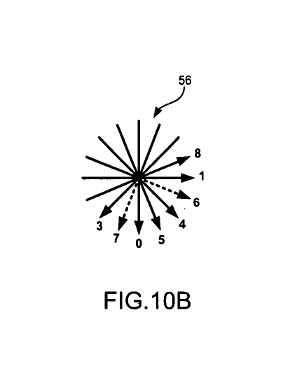

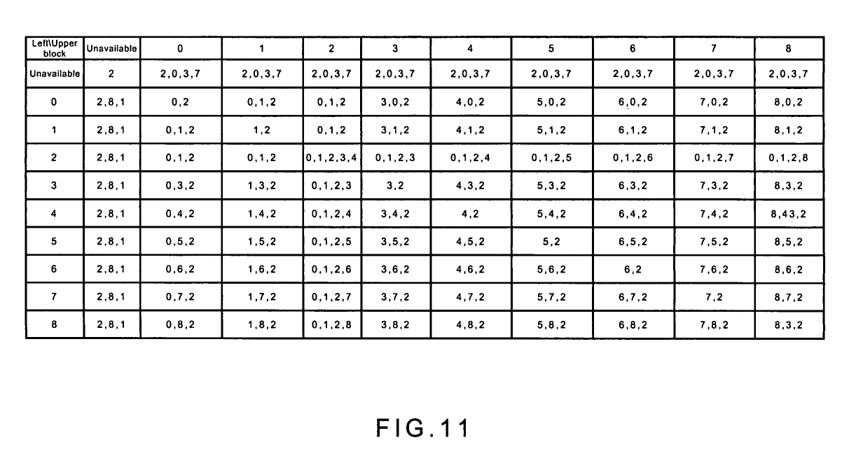

Please refer to FIG. 7 to FIG. 11, which are views showing a condition-correlation search method of a PCC-SA algorithm, a probability-correlation search method, a first and a second predictions of the probability-correlation search method, a non context-correlation search method, a prediction of the non context-correlation search method and a PCC-SA search table. As shown in the figures, a CC-SA algorithm used for an intra 4×∝macroblock requires 4.9 predicted modes. To minimize required time for a mode decision of the intra 4×4 macroblock, a PCC-SA algorithm is provided to improve efficiency. The PCC-SA algorithm is a refinement to the CC-SA algorithm, where a mode having a higher probability is selected to reduce predict modes to be calculated. Therefore, the PCC-SA algorithm only calculates 3.84 predicted modes for each block.

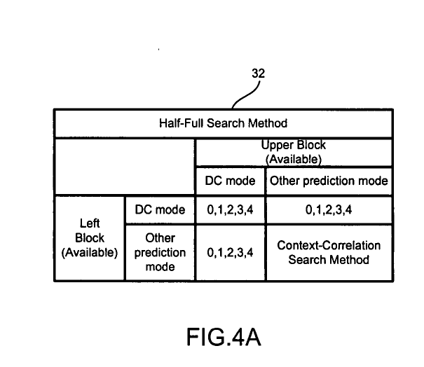

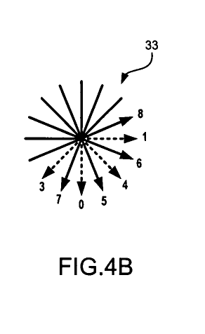

The condition-correlation search method 51 of the PCC-SA algorithm is basically the same as the condition-correlation search method 31 of the CC-SA algorithm. What differs is the refinement of the probability-correlation search method 52. In the probability-correlation search method of PCC-SA algorithm, when the predicted modes of the neighboring blocks are DC modes, predicted modes at all directions have to be calculated since direction is unknown. Yet, in the probability-correlation search method [52] of the PCC-SA algorithm, predicted modes are calculated to mode 0, mode 1, mode 2, mode 3 and mode 4 only [53], which is the same as the half-full search method [31] (as shown in FIG. 4A and FIG. 4B). When a neighboring block only has DC mode at a direction, predicted modes are calculated with mode 0, mode 1, mode 2 and mode of the neighboring block [54] . Mode 0 at vertical direction and mode 1 at horizontal direction are two major spatial directions and are two modes having the highest probabilities, which are thus included in the predicted modes to be calculated. Mode 2 gas no direction and thus is included since no information can be obtained from neighboring blocks. In addition, on obtaining mode decisions for macroblocks, it is known from statistics that the predicted modes of the neighboring blocks have high possibilities to be selected as the best predicted modes. Accordingly, the predicted modes of the neighboring blocks become modes to be calculated. When not one of the neighboring block has DC mode as predicted mode, only the predicted modes of the neighboring blocks and the DC mode are calculated for a mode decision. For example, the non context-correlation search method 55 and the predicted mode 56 have mode 6 and mode 7 as the predicted modes of the neighboring blocks at the left and the upper direction, and thus these two modes and DC mode are calculated. Accordingly, a PCC-SA search table is obtained with the condition-correlation search method 51, the probability-correlation search method 52 and the non context-correlation search method 55.

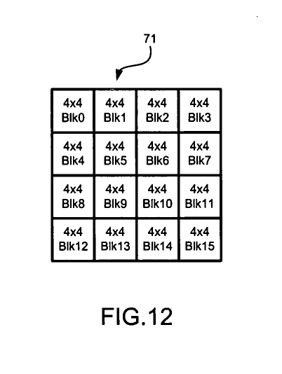

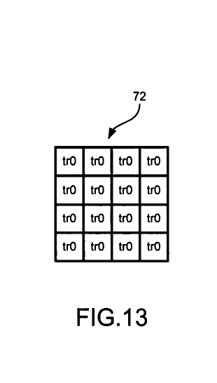

Please refer to FIG. 12 and FIG. 13, which are views showing a luma 16×16 macroblock and transformed residues of a 4×4 macroblock. As shown in the figures, and NDCB-SA algorithm is used for calculating a cost of a predicted mode for an intra 16×16 macroblock. At first, the 16×16 macroblock [71] is divided into 16 4×4 sub-macroblocks. A residue for each block in the 4×4 sub-macroblock is calculated. After a Hadamard transformation, a sum of absolute transformed differences (SATD) is obtained for each 4×4 sub-macroblock. Then the SATDs of the 16 sub-macroblocks are summed to obtain a total SATD for the 16×16 macroblock [71], which is also the cost of the 16×16 macroblock [71]. Thus, a best predicted mode is obtained. The formulas for the NDCB-SA algorithm are as follows:

$${SATD}_{4 \times 4 blk} = {\sum }_{i = 0}^{15} {tr}_{i}$$

$${COST}_{I 16 MB} = {\sum }_{4 \times 4 blk = 0}^{15} {SATD}_{4 \times 4 blk}$$

Therein , trᵢ is the transformed residues [72]; SATD_{4×4blk} is the sum of tr₀ to tr₁₅; and COST_{I16MB} is the sum of 16 SATDs for the intra 16×16 macroblock.

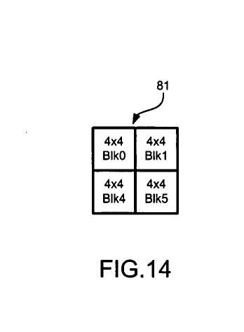

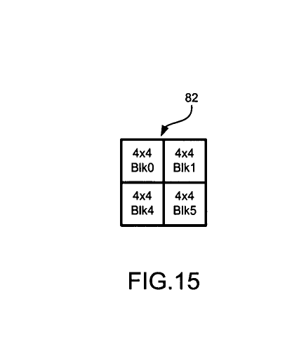

Please refer to FIG. 14 and FIG. 15, which are views showing a first color element macroblock and a second color element macroblock. As shown in the figures, chroma macroblocks are divided into first color element macroblocks 81 and second color element macroblocks 82. each color element macroblock has 4 4×4 blocks and 4 predicted modes. In the chroma macroblocks, spatial connections between blocks are not strong; prediction values for blocks are very close; and, human eyes are not sensitive to chroma changes. Hence, in a QMB-SA algorithm, only the most upper-left blocks are calculated to obtain a mode decision for each color element. Then costs for the first color element macroblock 81 and the second color element macroblocks 82 are summed to obtain cost for each predict mode of the chroma macroblocks [83]. In this way, 75% of calculations can be reduced. The formulas for the QMB-SA algorithm are as follows:

$$\begin{matrix}{COST}_{chroma} = {COST}_{1 st} + {COST}_{2 nd} \\ = {SATD}_{4 \times 4 blk 0} + {SATD}_{4 \times 4 blk 0}\end{matrix}$$

Therein, SATD_{4×4blk0} is the sum of SATDs of the most upper-left block; and, COST_{chroma} is the sum of costs for the two color elements.

Thus, three different levels of intra coding are provided. A CC-SA algorithm calculates 4.9 modes in a mode decision of block for intra 4×4 macroblocks with spatial correlations. According to occurrence rates of predicted modes, a PCC-SA algorithm is obtained with 3.84 modes calculated for further simplifying the CC-SA algorithm, which reduces 21% of calculation. Besides intra 4×4 macroblock, the present invention also provides proper methods for intra 16×16 macroblocks and chroma macroblocks, which are an NDCB-SA algorithm and a QMB-SA algorithm respectively. The present invention provides intra coding algorithms for different applications. The intra coding algorithms in level 0 is used for coding high-quality pictures without any quality loss. For portable products, intra coding algorithms in level 1 and level 2 can be used to save power consumption, which save 38% and 50% of total calculations respectively and have only little losses to picture quality. Thus, the present invention greatly reduces complexities in calculations and can be practiced in a hardware structure with a different reference table, which is simple and has no big hardware loading. Consequently, the present invention is an excellent solution to a quality-scaleable hardware.

To sum up, the present invention is H.264/AVC intra coding algorithms for a quality scalability, where, with intra coding algorithms for different applications, complexities in calculations are greatly reduced and coding efficiencies are improved; and thus a high efficiency, a high picture quality and a low power consumption are obtained suitable for practicing a low-cost hardware.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. H264/AVC intra coding algorithms for a quality scalability, comprising steps of:
(a) in a standard H.264/AVC intra coding, processing mode decisions to a plurality of intra 4×4 macroblocks, a plurality of intra 16×16 macroblocks and a plurality of chroma macroblocks separately to obtain best predicted modes for said plurality of intra 4×4 macro blocks, said plurality of intra 16×16 macroblocks and said plurality of chroma macro blocks; and
(b) after obtaining said best predicted modes, processing a texture coding to said best predicted modes separately,
wherein a scalable picture quality is obtained through algorithms processed in said mode decisions.

2. The intra coding according to claim 1,
wherein said algorithm processed in said mode decision for said plurality of intra 4×4 macro blocks is selected from a group consisting of a full search algorithm (Full-SA), a context condition search algorithm (CC-SA) and a probability condition correlation search algorithm (PCC-SA).

3. The intra coding according to claim 1,
wherein said algorithm processed in said mode decision for said plurality of intra 16×16 macroblocks is selected from a group consisting of a Normal-SA algorithm and a non DC block search algorithm (NDCB-SA).

4. The intra coding according to claim 1,
wherein said algorithm processed in said mode decision for said plurality of chroma macro blocks is selected from a group consisting of a Normal-SA algorithm and a quarter MB search algorithm (QMB-SA).

5. The intra coding according to claim 1,
wherein said mode decision comprises three coding levels, including level 0, level 1 and level 2.

6. The intra coding according to claim 5,
wherein algorithms processed in said three coding levels of said mode decisions comprises:
(a) a Full-SA algorithm processed in level 0 for a plurality of intra 4×4 macroblocks, a plurality of intra 16×16 macroblocks and a plurality of chroma macroblocks;
(b) a CC-SA algorithm, an NDCB-SA algorithm and a QMB-SA algorithm processed in level 1 for said intra 4×4 macroblocks, said intra 16×16 macroblocks and said chroma macroblocks, respectively; and
(c) a PCC-SA algorithm, an NDCB-SA algorithm and a QMB-SA algorithm processed in level 2 for said intra 4×4 macro blocks, said intra 16×16 macroblocks and said chroma macroblocks, respectively.

7. The intra coding according to claim 6,
wherein 16 residues of an block are processed through a Hadamard transformation in said NDCB-SA algorithm; and
wherein summed absolute values of sixteen blocks are summed to obtain a predicted cost of said intra 16×16 macroblock.

8. The intra coding according to claim 6,
wherein said QMB-SA algorithm processed in said mode decision for said chroma macroblocks comprises steps of:
(a) separating said chroma macroblocks into first chroma elements and second chroma elements, each chroma element comprising four predicted modes, each chroma element comprising four 4×4 blocks;
(b) processing a mode decision to the most upper-left block of each chroma element to obtain a cost of said chroma element; and
(c) aggregating costs of said first chroma elements and said second chroma elements to obtain a cost of said chroma macroblocks.

9. The intra coding according to claim 6,
wherein said CC-SA algorithm comprises a condition-correlation search method, a half-full search method and a context-correlation search method; and
wherein modes for said mode decision comprises mode 0 of a vertical mode, mode 1 of a horizontal mode, mode 2 of a decoding (DC) mode, mode 3 of a diagonal down-left mode, mode 4 of a diagonal down-right mode, mode 5 of a vertical-right mode, mode 6 of a horizontal-down mode, mode 7 of a vertical-left mode and mode 8 of a horizontal-up mode.

10. The intra coding according to claim 9,
wherein said condition-correlation search method obtains a best predicted mode through steps of:
(a) a calculation of DC mode when no neighboring block exists;
(b) calculations of mode 0, mode 2, mode 3 and mode 7 when a neighboring block exists at upper side only;
(c) calculations of mode 1, mode 2 and mode 8 when a neighboring block exists at left side only; and
(d) processing a half-full search method and a context-correlation search method when neighboring blocks exist at both said upper side and said left side.

11. The intra coding according to claim 9,
wherein said half-full search method is processed to an intra 4×4 block when a neighboring block is DC mode; and
wherein said half-full search method is processed to a half of predicted modes of said intra 4×4 macroblocks, including mode 0, mode 1, mode 2, mode 3 and mode 4.

12. The intra coding according to claim 9,
wherein said context-correlation search method processes calculations to a mode of an upper-side block, a mode of a left-side blocks, DC mode, and spatial directional predicted modes neighboring to said mode of said upper-side block and said mode of said left-side block.

13. The intra coding according to claim 9,
wherein a CC-SA search table is obtained through said condition-correlation search method, said half-full search method and said context-correlation search method with a reference to existence of neighboring blocks.

14. The intra coding according to claim 6,
wherein said PCC-SA algorithm comprises mode decisions of a condition-correlation search method, a probability-correlation search-method and a non context-correlation search method.

15. The intra coding according to claim 14,
wherein a PCC-SA search table is obtained through said condition-correlation search method, said probability-correlation search method and said non context-correlation search method with a reference to existence of neighboring blocks.

16. The intra coding according to claim 14,
wherein said PCC-SA algorithm processes said probability-correlation search method and said non context-correlation search method when both an upper-side neighboring block and a left-side neighboring block exist.

17. The intra coding according to claim 14,
wherein said PCC-SA algorithm processes said non context-correlation search method to calculate DC mode and predicted modes of said neighboring blocks when not a neighboring block has DC mode.

18. The intra coding according to claim 16,
wherein predicted modes to be calculated in said probability-correlation search method are decided according to states of DC mode in neighboring blocks; and
wherein each of said predicted modes is selected from a group consisting of mode 0 of a vertical mode, mode 1 of a horizontal mode, mode 2 of a DC mode, mode 3 of a diagonal down-left mode, mode 4 of a diagonal down-right mode, mode 5 of a vertical-right mode, mode 6 of a horizontal-down mode, mode 7 of a vertical-left mode and mode 8 of a horizontal-up mode.

19. The intra coding according to claim 18,
wherein mode 0, mode 1, mode 2, mode 3 and mode 4 are calculated when all said predicted modes of said neighboring blocks are DC mode.

20. The intra coding according to claim 18,
wherein mode 0, mode 1 and mode 2 are calculated together with a mode of a neighboring block at a direction when only a neighboring block at another direction is DC mode.
